(19) United States
(12) Patent Application Publication
(10) Pub. No.: US 2024/0165802 A1
(43) Pub. Date: May 23, 2024

(54) System and Method for Scheduling Tasks for Mobile Robots

(71) Applicant: ZEBRA TECHNOLOGIES CORPORATION, Lincolnshire, IL (US)

(72) Inventors: Annelise Pruitt, San Jose, CA (US); Tori Fujinami, Bozeman, MT (US); Agustin MacGregor Sevilla, Morgan Hill, CA (US); Rahul Rao, Sunnyvale, CA (US); Derek King, Seattle, WA (US); Daniel Rovner, Lincolnshire, IL (US); Gilberto Marcon dos Santos, San Jose, CA (US); Achal Arvind, Santa Clara, CA (US); Melonee Wise, San Jose, CA (US); Jenna Stephanie Guergah, Santa Cruz, CA (US)

(21) Appl. No.: 17/990,229

(22) Filed: Nov. 18, 2022

(51) Int. Cl. B25J 9/16; B25J 5/00; B25J 9/00

(52) U.S. Cl. CPC B25J 9/1661; B25J 5/007; B25J 9/0084; B25J 9/1689

(57) ABSTRACT

A server for scheduling mobile robots to perform tasks includes: a memory; and a processor configured to: obtain a planning period divided into a plurality of timeslots; obtain input constraints including (i) a number of mobile robots in a robot pool, (ii) a number of docks and (iii) a target number of active robots; obtain robot parameters and generate a robot agent based on the robot parameters for each mobile robot; define a work weight and a charge weight for each timeslot; determine, by each respective robot agent, a schedule portion based on the work weights, the charge weights and the robot parameters, the schedule portion selecting, for each timeslot for the mobile robot to work or to charge; and in response to determining that a finalization condition and the input constraints are satisfied by the schedule portions, send the schedule portions to each mobile robot.

### BACKGROUND

Autonomous or semi-autonomous mobile robots can be deployed in facilities such as warehouses, manufacturing facilities, healthcare facilities, or the like, e.g., to transport items within the relevant facility. Work tasks, such as instructions to travel to specified locations in the facility and retrieve certain items, can be assigned to mobile robots by a server. During execution of such work tasks, the battery level of the mobile robots may deplete, so the mobile robots may need to charge periodically. Manual scheduling of a fleet of robots to perform work tasks or to charge is time-consuming and error prone and may result in too few robots working or robots running out of battery.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for scheduling tasks for mobile robots.

FIG. 2 is a block diagram of certain components of a mobile robot of FIG. 1.

FIG. 3 is a block diagram of the application 144 of FIG. 1.

FIG. 4 is a flowchart of a method of scheduling tasks for mobile robots.

FIG. 5 is a diagram of an example work weight curve used at block 415 of the method of FIG. 4.

FIG. 6 is a diagram of an example dock weight curve used at block 415 of the method of FIG. 4.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a server comprising: a memory; and a processor interconnected with the memory, the processor configured to: obtain a planning period divided into a plurality of timeslots; obtain a planning period divided into a plurality of timeslots; obtain input constraints including (i) a number of mobile robots in the robot pool, (ii) a number of docks for charging the mobile robots and (iii) a target number of active robots available for work at a given timeslot; obtain robot parameters and generate a robot agent based on the robot parameters for each of the mobile robots; define a work weight and a charge weight for each timeslot in the planning period; determine, for each mobile robot by the respective robot agent, a schedule portion based on the work weights, the charge weights and the robot parameters, the schedule portion selecting, for each timeslot in the planning period for the mobile robot to work or to charge; and in response to determining that a finalization condition and the input constraints are satisfied by the schedule portions, send the schedule portions to each respective mobile robot to fulfill during the planning period.

Additional examples disclosed herein are directed to a method comprising: obtaining a planning period divided into a plurality of timeslots; obtaining input constraints including (i) a number of mobile robots in the robot pool, (ii) a number of docks for charging the mobile robots and (iii) a target number of active robots available for work at a given timeslot; obtaining robot parameters and generating a robot agent based on the robot parameters for each of the mobile robots; defining a work weight and a charge weight for each timeslot in the planning period; determining, for each mobile robot by the respective robot agent, a schedule portion based on the work weights, the charge weights and the robot parameters, the schedule portion selecting, for each timeslot in the planning period, for the mobile robot to work or to charge; and in response to determining that a finalization condition and the input constraints are satisfied by the schedule portions, sending the schedule portions to each respective mobile robot to fulfill during the planning period.

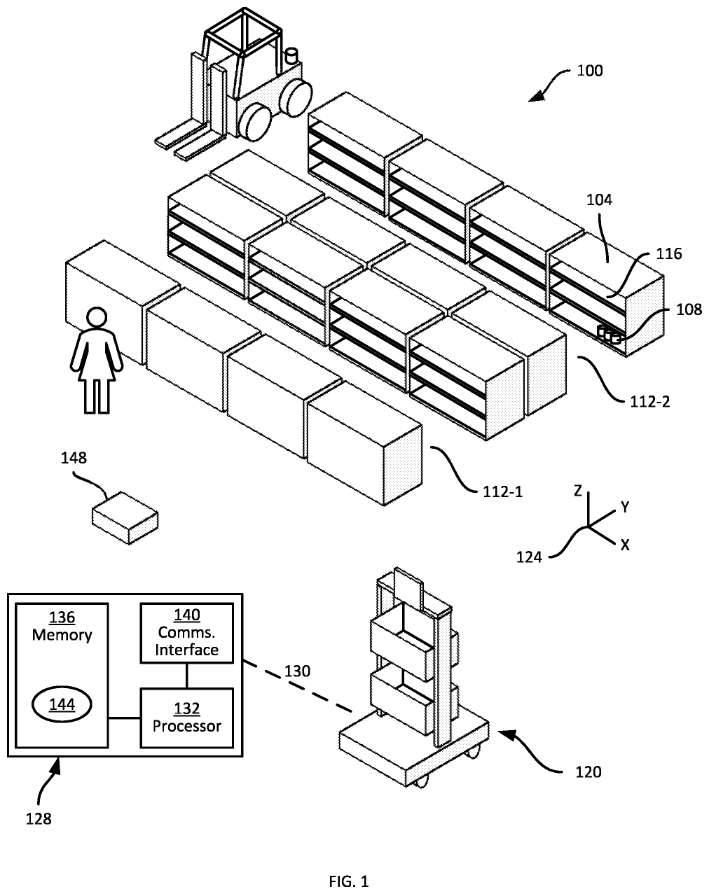

FIG. 1 illustrates an interior of a facility 100, such as a warehouse, a manufacturing facility, a healthcare facility, or the like. The facility 100 includes a plurality of support structures 104 carrying items 108. In the illustrated example, the support structures 104 include shelf modules, e.g., arranged in sets forming aisles 112-1 and 112-2 (collectively referred to as aisles 112, and generically referred to as an aisle 112; similar nomenclature is used herein for other components). As shown in FIG. 1, support structures 104 in the form of shelf modules include support surfaces 116 supporting the items 108. The support structures 104 can also include pegboards, bins, or the like, in other examples.

In other examples, the facility 100 can include fewer aisles 112 than shown, or more aisles 112 than shown in FIG. 1. The aisle 112, in the illustrated example, are formed by sets of eight support structures 104 (four on each side). The facility can also have a wide variety of other aisle layouts, however. As will be apparent, each aisle 112 is a space open at the ends, and bounded on either side by a support structure 104. The aisle 112 can be travelled by humans, vehicles, and the like. In still further examples, the facility 100 need not include aisles 112, and can instead include assembly lines, or the like.

The items 108 may be handled according to a wide variety of processes, depending on the nature of the facility 100. In some examples, the facility 100 is a shipping facility, distribution facility, or the like, and the items 108 can be placed on the support structures 104 for storage, and subsequently retrieved for shipping from the facility. Placement and/or retrieval of the items 108 to and/or from the support structures can be performed or assisted by a mobile robot 120. A fleet of mobile robots 120 can be deployed in the facility 100 having a number of mobile robots 120, for example based on the size and/or layout of the facility 100. Components of the robot 120 are discussed below in greater detail. In general, each robot 120 in the facility 100 is configured to transport items 108 within the facility 100.

Each robot 120 can be configured to track its pose (e.g., location and orientation) within the facility 100, e.g., in a coordinate system 124 previously established in the facility 100. The robot 120 can navigate autonomously within the facility 100, e.g., travelling to locations assigned to the robot 120 to receive and/or deposit items 108. The items 108 can be deposited into or onto the robot 120, and removed from the robot 120, by human workers and/or mechanized equipment such as robotic arms and the like deployed in the facility 100. The locations to which each robot 120 navigates can be assigned to the robot 120 by a central server 128. That is, the server 128 is configured to assign tasks to each robot 120. Each task can include either or both of one or more locations to travel to, and one or more actions to perform at those locations. For example, the server 128 can assign a task to the robot 120 to travel to a location defined in the coordinate system 124, and to await the receipt of one or more items 108 at that location.

Since the robot 120 is mobile, the robot 120 may be battery-operated and rechargeable at a charging dock 148. The facility 100 may have a plurality of docks 148 located at various locations around the facility 100. While performing work tasks around the facility 100, the battery of the robot 120 may drain, and hence in some examples, the tasks assigned to the robot 120 may include a charging task to charge at the dock 148.

Tasks can be assigned to the robot 120 via the exchange of messages between the server 128 and the robots 120, e.g., over a link 130 defined by a suitable combination of local and wide-area networks. The server 128 can be deployed at the facility 100 and communicate with the robot 120 via one or more local networks, e.g., wireless local area networks (WLANs) deployed within the facility 100. In other examples, the server 128 is located remotely from the facility 100, and can communicate with the robot 120 via a combination of local and wide area networks. In some examples, the server 128 is configured to assign tasks to robots 120 at multiple facilities.

The server 128 includes a processor 132, such as one or more central processing units (CPU), graphics processing units (GPU), or dedicated hardware controllers such as application-specific integrated circuits (ASICs). The processor 132 is communicatively coupled with a non-transitory computer readable medium such as a memory 136, e.g., a suitable combination of volatile and non-volatile memory elements. The processor 132 is also coupled with a communications interface 140, such as a wireless transceiver enabling the robot 120 to communicate with other computing devices, such as the mobile robots 120. The memory 136 can store a plurality of computer-readable instructions executable by the processor 132, such as a scheduling application 144 whose execution by the processor 132 configures the processor 132 to schedule work tasks and charging operations for each of the mobile robots 120 in the fleet.

In particular, there may be various work scheduling and charging constraints to be met to ensure that the fleet of robots 120 is appropriately deployed to meet the needs of the facility 100. Further, in some examples, a pool of robots 120 available for scheduling may be smaller than the fleet of robots of the facility 100, for maintenance and/or repair operations, or the like. There may be fewer charging docks 148 than robots 120 in the fleet or in the pool of available robots 120, for example to lower the cost of acquiring and maintaining the charging docks 148. Further, since an operator of the facility 100 may desire that a target number of robots 120 are active and available for work at a given time, the docks 148 may not be always in use. The target number of active robots may be set based on the tasks to be performed at a given time. However, the limited number of charging docks 148, the target number of active robots, and the charging constraints and requirements of the robots 120 may complicate charging management.

Accordingly, the scheduling operation performed by the server 128 may schedule work tasks and charging operations for each of the robots 120 to optimize the use of the charging docks 148 (i.e., the charging docks 148 are in use as often as possible), that the robots 120 do not run out of charge while performing work tasks, and that the target number of robots 120 are available to perform work tasks at any given time. The scheduling operation may also schedule work tasks and charging operations in consideration of various robot charge constraints, such as ensuring that the robots 120 are able to obtain a deep charge at their target frequency (e.g., once a week). In other examples, other facility, dock and robot constraints for consideration by the scheduling operation are also contemplated.

In operation, to schedule work tasks and charging operations for the mobile robots 120, the server 128 may generate a simulation including a plurality of robot agents, each representing one of the mobile robots 120 in the fleet, at least one work scheduling agent and a dock scheduling agent. The scheduling operation may be run for a defined planning period (e.g., a week) and divided into a plurality of timeslots (e.g., one hour). The server 128 may then run a market-based simulation, wherein the scheduling agents may generate weights to work and to charge, while the robot agents elect to work and to charge at each timeslot in a schedule portion (i.e., a portion of an overall schedule specific to the given mobile robot 120 represented by the robot agent, also referred to herein as a robot plan) based on the weights to optimize their individual combined selected weights (i.e., the score represented by the combination of work weights and charge weights associated with the selected action at each given timeslot) in view of various robot parameters (e.g., a current charge level, battery depletion model, and other battery constraints). The server 128 may iteratively update the weights and robot plans until the plans converge, or until another stop condition is met, as will be further described below.

Accordingly, the memory 136 can also store various scheduling, facility, dock, and robot parameters for use in the scheduling operation performed by the server 128.

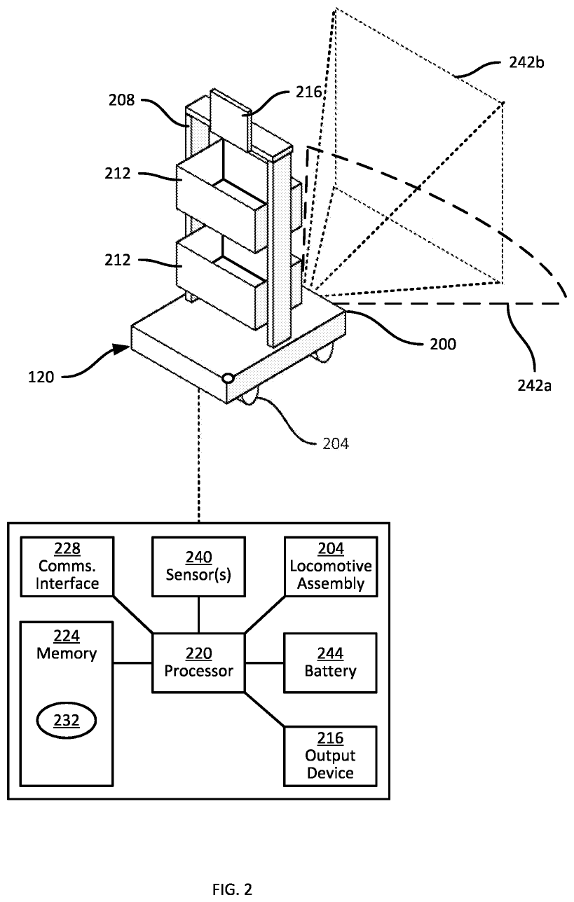

Before discussing the scheduling operation in greater detail, certain components of the robot 120 are discussed with reference to FIG. 2. As shown in FIG. 2, the robot 120 includes a chassis 200 supporting various other components of the robot 120. In particular, the chassis 200 supports a locomotive assembly 204, such as one or more electric motors driving a set of wheels, tracks, or the like. The locomotive assembly 204 can include one or more sensors such as a wheel odometer, an inertial measurement unit (IMU), and the like.

The chassis 200 also supports receptacles, shelves, or the like, to support items 108 during transport. For example, the robot 120 can include a selectable combination of receptacles 212. In the illustrated example, the chassis 200 supports a rack 208, e.g., including rails or other structural features configured to support receptacles 212 at variable heights above the chassis 200. The receptacles 212 can therefore be installed and removed to and from the rack 208, enabling distinct combinations of receptacles 212 to be supported by the robot 120.

The robot 120 can also include an output device, such as a display 216. In the illustrated example, the display 216 is mounted above the rack 208, but it will be apparent that the display 216 can be disposed elsewhere on the robot 120 in other examples. The display 216 can include an integrated touch screen or other input device, in some examples, The robot 120 can also include other output devices in addition to or instead of the display 216. For example, the robot 120 can include one or more speakers, light emitters such as strips of light-emitting diodes (LEDs) along the rack 208, and the like.

The chassis 200 of the robot 120 also supports various other components, including a processor 220, e.g., one or more central processing units (CPUs), graphics processing units (GPUs), or dedicated hardware controllers such as application specific integrated circuits (ASICs). The processor 220 is communicatively coupled with a non-transitory computer readable medium such as a memory 224, e.g., a suitable combination of volatile and non-volatile memory elements. The processor 220 is also coupled with a communications interface 228, such as a wireless transceiver enabling the robot 120 to communicate with other computing devices, such as the server 128 and other robots 120.

The memory 224 stores various data used for autonomous or semi-autonomous navigation, including an application 232 executable by the processor 220 to implement navigational and other task execution functions. In some examples, the above functions can be implemented via multiple distinct applications stored in the memory 224. Through execution of the application 232, the processor 220 can generate a wide variety of operational data as noted above, and store the operational data in the memory 224.

The chassis 200 can also support a sensor 240, such as one or more cameras and/or depth sensors (e.g., lidars, depth cameras, time-of-flight cameras, or the like) coupled with the processor 220. The sensor(s) 240 are configured to capture image and/or depth data depicting at least a portion of the physical environment of the robot 120. Data captured by the sensor(s) 240 can by used by the processor 220 for navigational purposes, e.g., path planning, obstacle avoidance, and the like.

The sensors 240 have respective fields of view (FOVs). For example, a first FOV 242a corresponds to a laser scanner, such as a lidar sensor disposed on a forward-facing surface of the chassis 200. The FOV 242a can be substantially two-dimensional, e.g., extending forwards in a substantially horizontal plane. A second FOV 242b corresponds to a camera (e.g., a depth camera, a color camera, or the like) also mounted on the forward-facing surface of the chassis 200. As will be apparent, a wide variety of other optical sensors can be disposed on the chassis 200 and/or the rack 208, with respective FOVs 242.

The components of the robot 120 that consume electrical power can be supplied with such power from a battery 244, e.g., implemented as one or more rechargeable batteries housed in the chassis 200 and rechargeable via the charging dock 148 or other suitable charging interface.

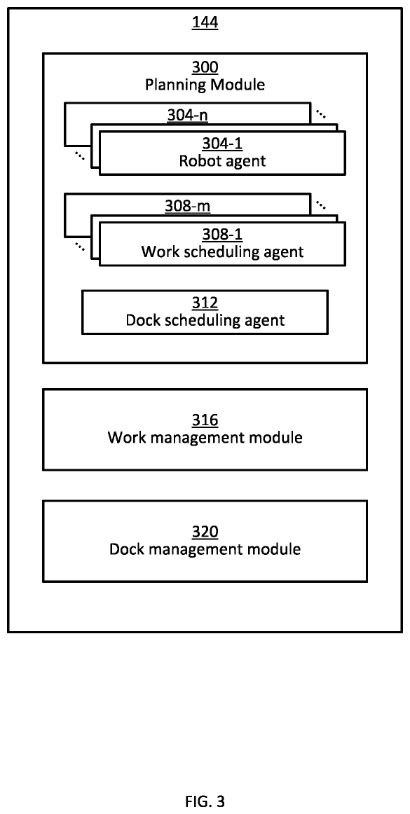

Referring to FIG. 3, a block diagram of the application 144 is depicted. In particular, as noted above, to run the scheduling operation (i.e., via execution of the application 144), the server 128 may simulate the various system components of the facility 100 as a plurality of agents.

Thus, the application 144 may include a scheduling module 300, also referred to herein as planning module 300, which in turn includes a plurality of robot agents 304-1, . . . , 304-n. Each robot agent 304 represents one of the mobile robots 120 in the facility 100. The planning module 300 further includes a plurality of work scheduling agents 308-1, . . . , 308-m. Each work scheduling agent corresponds to a work schedule for the facility 100. For example, the facility 100 may have a work schedule for different sets of tasks grouped, for example by region of the facility, by type of task, by project, or other suitable groupings. Each work schedule may be represented in the simulation for the scheduling operation by a respective work scheduling agent 308. The planning module 300 further includes a dock scheduling agent 312 to manage the availability of the docks 148 about the facility 100.

During a scheduling operation, the application 144 may call the planning module 300 to generate a schedule for a given planning period. The planning module 300 may then generate a schedule assigning robots 120 to work or to charge at each timeslot in the planning period. In particular, the planning module 300 may initiate the robot agents 304, the work scheduling agents 308 and the dock scheduling agent 312 to generate the schedule.

In some examples, the application 144 may additionally have a work management module 316 and a dock management module 320. After generation of the schedule assigning robots 120 to work or to charge at each timeslot, the work management module 316 may assign specific work tasks to specific robots 120 from the set of robots 120 assigned to work at a given timeslot. For example, the specific work tasks may include a location to which to travel, and one or more actions to perform at the location. Similarly, the dock management module 320 may assign specific charging tasks to specific robots 120 from the set of robots 120 assigned to charge at a given timeslot. For example, the specific charging task may be the designation of a particular charging dock 148 at which the robot 120 should charge, or a staging location to wait for a charging dock 148.

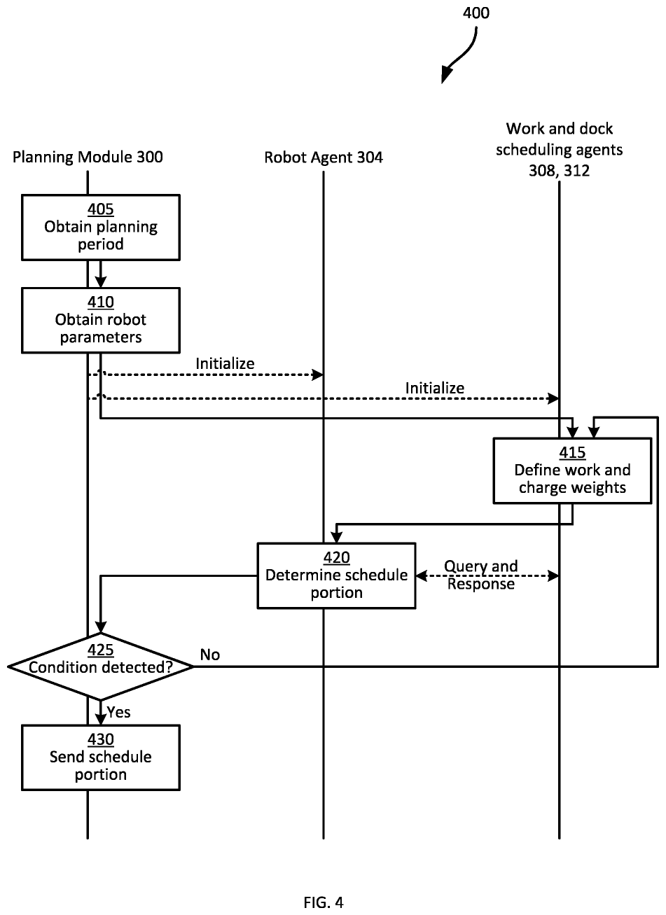

Turning now to FIG. 4, a method 400 of scheduling a plurality of mobile robots to perform tasks is illustrated. The method 400 is discussed below in conjunction with its example performance in the facility 100. In particular, the method 400 is performed by the server 128 via execution of the application 144 by the processor 132, and more specifically, via execution of the planning module 300 and the agents 304, 308, and 312. As described herein, performance of various functionality by the agents 304, 308 and 312 may be achieved via execution of the computer-readable instructions contained therein by the processor 132.

At block 405, the scheduling operation is initiated, for example in response to a request by an operator to generate a schedule, or periodically at predefined intervals (e.g., based on facility parameters). The planning module 300 may obtain a planning period over which the schedule is to be generated and divide the planning period into timeslots. The planning period may be a period in the future, or the planning period may be ongoing, if for example, the method 400 is performed to update a schedule or plan based on real-time unexpected constraints. In such examples, the planning module 300 may obtain the planning period of the currently active schedule or plan. In other examples, the request may define the planning period and a designated length of timeslot into which the planning period should be divided. In other examples, a predefined length of timeslots may be retrieved from the memory 136.

The planning module 300 may additionally obtain input constraints including the number of mobile robots available for the scheduling operation (i.e., the number of robots in a robot pool for the scheduling operation), a number of docks available for charging the mobile robots and the target number of active robots. For example, the request may specify the robot pool of mobile robots to schedule and the docks available for charging. The robot pool and the docks may be indicated, for example, by an operator annotating a map of the facility.

At block 410, the planning module 300 may initiate the market-based simulation. In particular, the planning module 300 may obtain robot parameters for each mobile robot 120. The robot parameters may include a current battery level of the robot 120, a last deep charge time, a target deep charge frequency, and a battery level model. In some examples, the robot parameters may additionally include work tasks and charging operations assigned to the robot 120 until the beginning of the planning period, to allow the planning module 300 to estimate a battery level of the robot 120 at the beginning of the planning period.

After obtaining the robot parameters from each mobile robot 120, the planning module 300 initializes or generates a robot agent 304 for each mobile robot 120 based on the respective robot parameters for each of the mobile robots 120 in the robot pool.

In addition to initializing the robot agents 304 for the simulation, the planning module 300 may additionally initialize a work scheduling agent 308 for each work schedule, as well as the dock scheduling agent 312 to manage the docks.

Accordingly, at block 415, the work scheduling agents 308 and the dock scheduling agent 312 may define work weights and charge weights, respectively, for each timeslot in the planning period. In particular, the work weights represents a simulated monetary or other quantitative weight to incentivize the robot agents 304 to elect to work during the corresponding timeslot. Similarly, the charge weights represent a weight to incentivize the robot agents 304 to elect to charge during the corresponding timeslot.

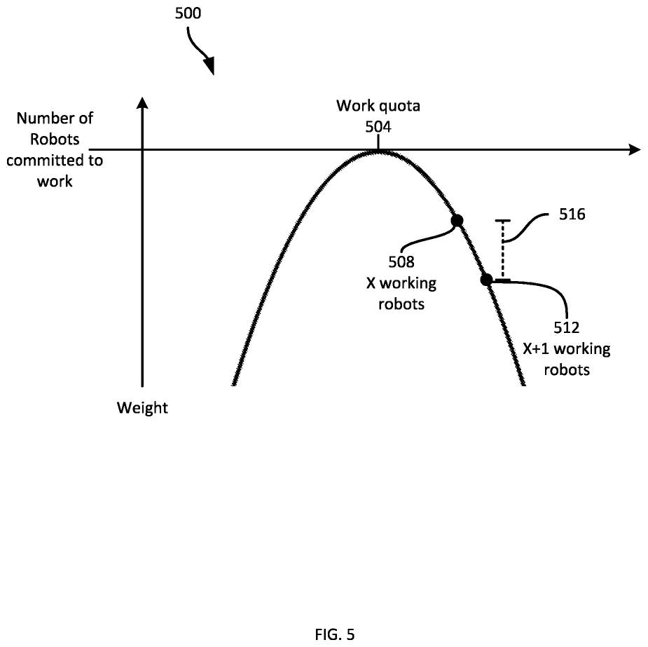

Each work scheduling agent 308 may define a work weight for each timeslot in the planning period based on the tasks and/or activities scheduled in the corresponding work schedule. That is, if a work schedule includes one or more tasks for a given timeslot, the corresponding work scheduling agent 308 may define a non-zero work weight for that timeslot to incentivize robots 304 to elect to work during that timeslot. In some examples, the work weights may be computed by the work scheduling agents 308 based on a predefined weight curve. For example, referring to FIG. 5, an example work weight curve 500 is illustrated.

The work weight curve 500 may be a symmetric function, centered around a work quota 504, representing a target number of robots committed to the work scheduling agent 308. In the present example, the work weight curve 500 is a second order parabola with a maximum (i.e., a highest weight or score along the y-axis) when the number of robots committed to work (i.e., the x-axis) equals the work quota 504. In other examples, the work weight curve 500 may be defined by other suitable functions.

To compute the work weight for a robot agent 304, the work scheduling agent 308 may evaluate a difference in value of the work weight curve based a previous iteration of the robot plans with and without an additional robot committed to the work scheduling agent 308. That is, the work weight curve 500 takes the previous iteration of the robot plans as an input and is evaluated if the robot agent 304 does not commit to working for the work scheduling agent 308 to obtain a first weight 508. That is, the first weight 508 is evaluated based on the number of robot agents 304 which committed to the work scheduling agent 308 at the previous iteration in the simulation (i.e., based on the robot plans determined at block 420, as will be described further below, of a previous iteration). The work weight curve 500 is also evaluated if the robot agent 304 does commit to working for the work scheduling agent 308 to obtain a second weight 512. That is, the second weight 508 is evaluated based on the number of robot agents 304 which committed to the work scheduling agent 308 at the previous iteration in the simulation plus the robot agent 304 requesting the work weight. At the initial iteration of the simulation, each of the robot agents 304 may be assumed to have committed to the dock scheduling agent 312 to charge. A difference 516 between the weights 508 and 512 is then defined as the work weight. Other manners of computing the work weight are also contemplated.

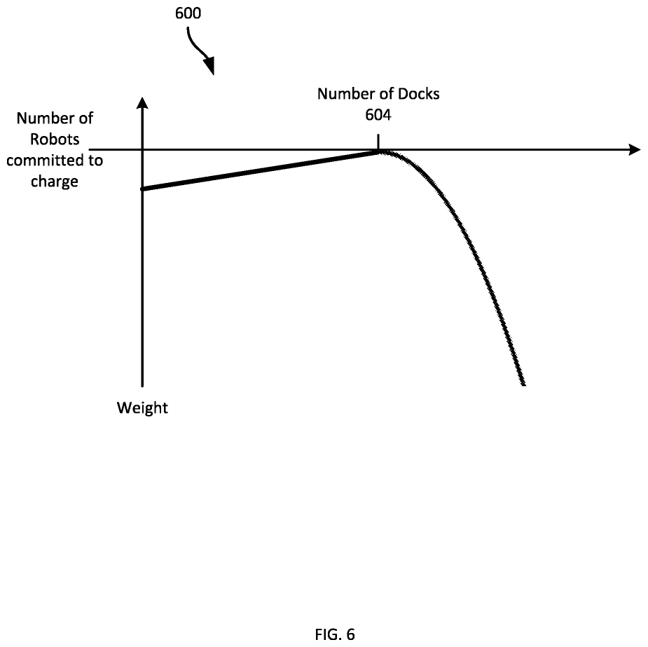

The dock scheduling agent 312 may define a charge weight for each timeslot in the planning period based on dock constraints (e.g., a number of available docks 148 and the like) and to incentivize as many robots 120 as possible to be charging at the docks 148. In some examples, the charge weights may be computed by the dock scheduling agent 312 based on a predefined charge weight curve. For example, referring to FIG. 6, an example charge weight curve 600 is illustrated. The charge weight curve 600 may similarly take a previous iteration of the robot plans as an input to compute a weight for a current iteration.

The charge weight curve 600, in the present example is not symmetric. The charge weight curve 600 is maximized (i.e., a highest weight or score along the y-axis) at the number of available docks 604. That is, the charge weight curve 600 is maximized when the number of robots committed to charge (i.e., the x-axis) matches the number of available docks and drops linearly to a minimum weight. The minimum weight may be selected based on the number of robots and the number of docks to incentivize robots to dock if not all docks are used, and to prevent robots from preferring docking over working.

In other examples, other weight curves may be used to allow the dock scheduling agent 312 to define suitable charge weights. Further, in some examples, the dock scheduling agent 312 may additionally evaluate environmental conditions of the facility 100 (e.g., the weather, which may correspond to an expected temperature) when defining charge weights. For example, the dock scheduling agent 312 may increase the charge weights during colder periods to incentivize charging at those times of day, since robots 120 charge more slowly as temperature increases.

Returning to FIG. 4, at block 420, each robot agent 304 determines a robot plan or schedule portion, which defines, for each timeslot in the planning period, an intent or commitment of the robot agent 304 to work or to charge. That is, the robot agent 304 selects, for each timeslot in the planning period, for the mobile robot 120 to work or to charge to generate the schedule portion corresponding to that mobile robot 120.

In particular, for each timeslot in the planning period, the robot agent 304 requests or queries, from each work scheduling agent 308 and from the dock scheduling agent 312, the work weights and charge weights defined at block 415. The robot agent 304 may then elect, for each timeslot, whether to work or to charge based on the work weights, the charge weights, and the robot parameters. In particular, the robot agent 304 may elect to work or to charge to optimize combined selected weights from the work and charge weights, while satisfying its battery constraints, such as not allowing the battery level to drop below a threshold value (i.e., so as not to deplete its battery in the middle of a work task), obtaining a deep charge at the target deep charge frequency, and the like.

Each robot agent 304 may determine its robot plan independently of the other robot agents 304, based on the work and charge weights and its own robot parameters, without consideration of the commitments of the other robot agents 304. Thus, the optimization performed by the server 128 for each robot agent 304 has fewer variables to consider, and hence is computationally simpler and less resource intensive. Additionally, the robot agents 304 may determine their respective robot plans in sequence or in parallel.

At block 425, the robot agents 304 return the robot plans to the planning module 300 to allow the planning module 300 to determine whether a plan finalization condition is detected and whether the input constraints obtained at block 405 have been satisfied.

In particular, since the robot agents 304 determine their respective robot plans independently of one another, the determined robot plans or schedule portions may not satisfy the input constraints, such as the target number of active robots. If the input constraints are satisfied, the planning module 300 may additionally consider a finalization condition to determine whether to continue to optimize the schedule or to finalize the schedule.

The finalization condition to allow the planning module 300 to finalize the determined robot plans may be that a current iteration of the robot plans match a previous iteration of the robot plans. Thus the server 128 may perform at least two iterations of blocks 415 and 420 before finalizing the robot plans. In some examples, in addition to checking that the current and previous iterations of the robot plans match, the planning module 300 may additionally check that the current and previous iterations of the work and charge weights (i.e., the work and charge weights which lead to the matching robot plans) also match. Thus, the planning module 300 may determine that the plan finalization condition is detected when the robot plans, the work weights, and the charge weights converge.

In other examples, the plan finalization condition may be that minimum work schedule and dock constraints have been satisfied, or other suitable conditions.

If, at block 425, the planning module 300 determines that the plan finalization condition has not been met, then the method 400 returns to block 415 to update the work weights and the charge weights based on the current robot plans. In particular, the planning module 300 may send the robot plans to the work scheduling agents 308 and the dock scheduling agent 312 to input to their respective weight curves to update the work and charge weights. The server 128 may then continue to iterate to determine new robot plans and update the work and charge weights until the plan finalization condition has been met.

For example, Table 1 illustrates example schedule portions determined by the robot agents 304 for three robots, A, B, and C to work or to charge in timeslots T1 through T5, as well as the number of active robots (i.e., the number of robots working at a given timeslot).

TABLE 1
Determined Schedule Portions - Iteration 1

| | | | | Number of |
|---|---|---|---|---|
| Timeslot | Robot A | Robot B | Robot C | Active Robots |
| T1 | Work | Work | Charge | 2 |
| T2 | Charge | Work | Charge | 1 |
| T3 | Charge | Work | Work | 2 |
| T4 | Charge | Charge | Charge | 0 |
| T5 | Work | Charge | Work | 2 |

In the present example, the target number of active robots may be 2, and hence timeslots T2 and T4 lack the target number of active robots. Accordingly, the planning module 300 determines that the input constraints, particularly the target number of active robots, have not been satisfied by this iteration of the determined schedule portions. The planning module 300 may therefore return to block 415 to update the work weights and the charge weights.

Table 2 illustrates example schedule portions determined in a second iteration after the work weights and charge weights are updated.

TABLE 2
Determined Schedule Portions - Iteration 2

| | | | | Number of |
|---|---|---|---|---|
| Timeslot | Robot A | Robot B | Robot C | Active Robots |
| T1 | Work | Work | Charge | 2 |
| T2 | Charge | Work | Work | 2 |
| T3 | Charge | Work | Work | 2 |
| T4 | Work | Charge | Work | 2 |
| T5 | Work | Charge | Work | 2 |

At the second iteration illustrated in Table 2, the robot agent 304 corresponding to Robot A may elect for Robot A to work at T4 rather than to charge based on the robot parameters of Robot A and the updated work and charge weights. Additionally, the robot agent 304 corresponding to Robot C may elect for Robot C to work at both T2 and T4 rather than to charge based on the robot parameters of Robot C and the updated work and charge weights. Thus, T2 and T4 may both now satisfy the target number of active robots. The planning module 300 may determine that the input constraints, particularly the target number of active robots, have been satisfied by this iteration of the determined schedule portions. The planning module 300 may therefore check whether the finalization condition has also been satisfied and return to block 415 or proceed to block 430 accordingly.

If, at block 425, the planning module 300 determines that the plan finalization condition has been met, then the method 400 proceeds to block 430. At block 430, the planning module 300 finalizes the robot plans and sends the finalized robot plans to each respective robot 120 to fulfill during the planning period.

In particular, to finalize the robot plans for a given robot, the planning module 300 assigns the robot 120 to work or to charge during a given timeslot based on the election to work or to charge made by the corresponding robot agent 304 in the proposed robot plan. Further, the planning module 300 may assign to the given robot 120, a specific work task or charging task for each timeslot in the planning period.

In some examples, after assigning each of the robots 120 to work or to charge during each timeslot in the planning period, the planning module 300 may additionally provide, to the work management module 316, the schedule of robots 120 assigned to work and the timeslots of the planning period at which each robot is assigned to work. The work management module 316 may then assign specific work tasks to each robot 120. For example, the work management module 316 may additionally obtain a map of the facility (e.g., from the memory 136) and assign locations to which to navigate and/or actions to take at the target location.

The planning module 300 may additionally provide, to the dock management module 320, the schedule of robots 120 assigned to charge and the timeslots of the planning period at which each robot 120 is assigned to charge. The dock management module 320 may then assign specific charging tasks to each robot 120. For example, the dock management module 320 may additionally obtain a map of the facility and assign docks 148 at which a given robot 120 should charge and/or a staging location at which a given robot 120 should wait to charge. The staging location may be designated, for example when a robot is not assigned to a particular dock 148 at which to charge, and is also not assigned to work. In some examples, the robot 120 may be assigned to enter a low-power state (e.g., where some of the computing processes are disabled) until the next assigned task.

The finalized robot plans may then be sent to the respective robots 120. When the planning period begins, the robots 120 may fulfil their respective schedule portion by performing the tasks assigned at each timeslot in the planning period.

In some examples, the server 128 may be configured to rerun the method 400 in response to a trigger condition. For example, the trigger condition may be expiry of a predefined time period, to rerun the method 400 periodically (e.g., every 15 minutes) to account for changes due to real-time production events. In other examples, the trigger condition may be a specific event, such as the battery of a robot 120 depleting more quickly than expected based on the battery level model, various tasks being unable to be completed due to navigational constraints (e.g., an area being blocked or the like), and similar. In response to detecting such a trigger condition, the server 128 may also rerun the method 400. In particular, the server 128 may obtain updated robot parameters, and propose new robot plans and update the work weights and the charge weights until the plan finalization condition is satisfied with the updated robot parameters. In such examples, the method 400 may be applied with the same planning period as the original plan.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A server for scheduling a plurality of mobile robots in a robot pool to perform tasks, the server comprising:
a memory; and
a processor interconnected with the memory, the processor configured to:
obtain a planning period divided into a plurality of timeslots;
obtain input constraints including (i) a number of mobile robots in the robot pool, (ii) a number of docks for charging the mobile robots and (iii) a target number of active robots available for work at a given timeslot;
obtain robot parameters and generate a robot agent based on the robot parameters for each of the mobile robots;
define a work weight and a charge weight for each timeslot in the planning period;
determine, for each mobile robot by the respective robot agent, a schedule portion based on the work weights, the charge weights and the robot parameters, the schedule portion selecting, for each timeslot in the planning period for the mobile robot to work or to charge; and
in response to determining that a finalization condition and the input constraints are satisfied by the schedule portions, send the schedule portions to each respective mobile robot to fulfill during the planning period.

2. The server of claim 1, wherein the finalization condition comprises a current iteration of the schedule portions matching a previous iteration of the schedule portions.

3. The server of claim 2, wherein the finalization condition further comprises a current iteration of the work weights and the charge weights matching a previous iteration of the work weights and the charge weights.

4. The server of claim 1, wherein the processor is further configured to assign, to each mobile robot, a work task for each timeslot in which the robot agent elected to work and a charging task for each timeslot in which the robot agent elected to charge.

5. The server of claim 4, wherein the charging task comprises entering a low-power state at a designated staging location.

6. The server of claim 1, wherein to determine the schedule portions, each robot agent is configured to optimize combined weights from the work weights and the charge weights in view of the robot parameters.

7. The server of claim 1, wherein the robot parameters comprise one or more of: a current battery level, a last deep charge time, a target deep charge frequency, and a battery level model.

8. The server of claim 1, wherein the work weights and the charge weights are defined based on a work weight curve and a charge weight curve, respectively.

9. The server of claim 8, wherein the work weight curve and the charge weight curve take a previous iteration of the schedule portions as input.

10. The server of claim 1, wherein the processor is further configured to:
in response to a trigger condition, obtain updated robot parameters;
pass the updated robot parameters to the respective robot agents to determine new schedule portions; and
in response to determining that the finalization condition and the input constraints are satisfied by the new schedule portions, send the new schedule portions to each respective mobile robot to fulfill during the planning period.

11. The server of claim 1, wherein the processor is further configured to: in response to determining that the finalization condition is not satisfied by the schedule portions, update the work weights and the charge weights based on the schedule portions and determining new schedule portions until the finalization condition is satisfied.

12. The server of claim 1, wherein the number of docks is smaller than the number of mobile robots in the robot pool.

13. A method for scheduling a plurality of mobile robots in a robot pool to perform tasks, the method comprising:
obtaining a planning period divided into a plurality of timeslots;
obtaining input constraints including (i) a number of mobile robots in the robot pool, (ii) a number of docks for charging the mobile robots and (iii) a target number of active robots available for work at a given timeslot;
obtaining robot parameters and generating a robot agent based on the robot parameters for each of the mobile robots;
defining a work weight and a charge weight for each timeslot in the planning period;
determining, for each mobile robot by the respective robot agent, a schedule portion based on the work weights, the charge weights and the robot parameters, the schedule portion selecting, for each timeslot in the planning period, for the mobile robot to work or to charge; and
in response to determining that a finalization condition and the input constraints are satisfied by the schedule portions, sending the schedule portions to each respective mobile robot to fulfill during the planning period.

14. The method of claim 13, wherein the finalization condition comprises a current iteration of the schedule portions matching a previous iteration of the schedule portions.

15. The method of claim 14, wherein the finalization condition further comprises a current iteration of the work weights and the charge weights matching a previous iteration of the work weights and the charge weights.

16. The method of claim 13, further comprising assigning, to each mobile robot, a work task for each timeslot in which the robot agent elected to work and a charging task for each timeslot in which the mobile robot elected to charge.

17. The method of claim 16, wherein the charging task comprises entering a low-power state at a designated staging location.

18. The method of claim 13, wherein determining the schedule portions comprises optimizing combined weights from the work weights and the charge weights in view of the robot parameters.

19. The method of claim 13, wherein the robot parameters comprise one or more of: a current battery level, a last deep charge time, a target deep charge frequency, and a battery level model.

20. The method of claim 13, further comprising defining the work weights and the charge weights based on a work weight curve and a charge weight curve, respectively.

21. The method of claim 20, wherein the work weight curve and the charge weight curve take a previous iteration of the schedule portions as input.

22. The method of claim 13, further comprising:
in response to a trigger condition, obtaining updated robot parameters;
pass the updated robot parameters to the respective robot agents to determine new schedule portions; and
in response to determining that the finalization condition and the input constraints are satisfied by the new schedule portions, send the new schedule portions to each respective mobile robot to fulfill during the planning period.

23. The method of claim 13, further comprising: in response to determining that the finalization condition is not satisfied by the schedule portions, updating the work weights and the charge weights based on the schedule portions and determining new schedule portions until the finalization condition is satisfied.

24. The method of claim 13, wherein the number of docks is smaller than the number of mobile robots in the robot pool.
